(19) United States
(12) Patent Application Publication
(10) Pub. No.: US 2009/0180437 A1
(43) Pub. Date: Jul. 16, 2009

(54) COMMUNICATION APPARATUS AND HANDOVER METHOD

(76) Inventor: Takeshi Kanazawa, Kanagawa (JP)

Correspondence Address: Dickinson Wright PLLC;James E. Ledbetter, Esq., International Square, 1875 Eye Street, N.W., Suite 1200, Washington, DC, 20006, US

(21) Appl. No.: 12/298,677

(22) PCT Filed: Apr. 28, 2006
(86) PCT No.: PCT/JP2006/308967

§ 371 Date: Feb. 20, 2009

(51) Int. Cl. H04W 36/00

(52) U.S. Cl. 370/331

(57) ABSTRACT

A communication apparatus controls the timing of switching data paths in an upper-layer apparatus so as to inhibit the data from being transferred from the network host of a handover source to the network host of a handover destination, thereby effectively utilizing the resource of the network host of the handover source, while eliminating the processing load accompanying the data transfer. In this apparatus, a handover deciding part (104) selects, based on the information of the reception qualities of a plurality of network hosts, the network host of a handover destination. A switching request part (105) makes a request of a path switching to IPAG. A handover instructing part (108) instructs a communication terminal apparatus to handover to the network host of the handover destination.

### TECHNICAL FIELD

The present invention relates to a communication apparatus and a handover method, and relates, for example, to a communication apparatus and a handover method for carrying out packet communications using mobile IP technology.

### BACKGROUND ART

Network layer protocols supporting the Internet (hereinafter “IP”) are used to manage and control data that flows from the source node to the target node in the form of IP data, by connecting with networks or subnetworks making up the Internet. In order to ensure reliable delivery of IP data packets, every node is assigned an IP address which defines the location of the node on a fixed network. Generally, IF is designed to support routing of IP packets between fixed network nodes.

However, accompanying the rapid development of radio nodes, there is a growing demand for providing IP support for mobile terminals in the same way as for fixed nodes. Here, fixed nodes generally do not move. Furthermore, mobile terminals can move within, for example, the area of the subnetworks or local network (LAN) segments. Furthermore, mobile terminals can also change the point of access to the subnetworks or LAN segments regularly through different network hosts. Furthermore, as is immediately understood by those skilled in the art, a compatible network host severs as a proxy for mobile terminals.

In order to ensure that data is correctly routed to a mobile terminal and maintains its continuity even if the point of access to the subnetworks or LAN and the IP address of the mobile terminal change regularly, the mobile terminal registers itself through connections with the subnetworks or LAN. This registration processing involves creating and saving registration records in the network hosts via connecting mobile terminals. That is, a network host is able to manage or support requests for move from mobile terminals using information including the registered records. For example, a network host may receive and process IP packet data from a mobile terminal and later send the processed IP data packet to another mobile terminal. When a mobile terminal keeps moving from one network host to another new network host, the mobile terminal carries out the process called “handover,” whereby the mobile terminal terminates its registration with the old network host and registers itself with the new network host. The process of terminating registrations involves terminating registration record from the old network host. The process of terminating mobile terminal registrations is extremely important. For example, terminating mobile terminal registrations makes it no longer necessary to consume network resources and contributes to security. On the other hand, if terminating a mobile registration fails, one or more hosts react to the mobile terminal as a proxy, which makes the routing of IP data packets inadequate and leads to unacceptable network malfunctions.

Non-Patent Document 1 is known to disclose a conventional method of handover between network hosts. The method of handover between network hosts disclosed in Non-Patent Document 1 will be explained using FIG. 1. FIG. 1 is a sequence diagram showing a conventional handover method. In FIG. 1, a mobile terminal (“UE”) carries out a handover from a source E-Node B to a target E-Node B.

First, to allow the source E-Node B to determine an appropriate target E-Node B for a handover, the UE reports, to the source E-Node B, the received quality of the target E-Node B of each candidate cell at the UE (i.e. measurement report) (step ST11).

Next, the source E-Node B, having received the received quality of each target E-Node B, determines the target E-Node B to be the handover destination, based on the received quality, resources and processing load of each target E-Node B (i.e. HO decision).

Next, the source E-Node B transfers the context of the UE including the radio bearer information and QoS information, to the target E-Node B determined to be the handover destination (i.e. context transfer) (step ST12), and inquires as to whether or not the mobile terminal is allowed to perform a handover.

Next, the target E-Node B allocates resources to the UE according to the QoS information included in the UE context transferred by the source E-Node B (i.e. resource allocation), thereby booking resources.

Next, when the target E-Node B has successfully booked the resources which the target E-Node B requires in conjunction with the UE, the target E-Node B reports to the source E-Node B that the preparation for the handover is complete (i.e. context transfer response) (step ST13).

Next, the source E-Node B transfers, to the target E-Node B, user packets which the source E-Node B has sent to the UE and which nevertheless has not been returned an ACK indicating successful reception, from the UE, and user packets which the source E-Node B has received from the access gateway (“access GW”) and which the source E-Node B nevertheless has not sent to the UE (i.e. start packet data forwarding) (step ST14).

Next, the source E-Node B commands the UE to perform a handover to the target E-Node B, and sends to the UE the cell-specific parameters that are necessary to communicate with the target E-Node B (i.e. RB reconfiguration) (step ST15).

Next, the UE having received the cell-specific parameters synchronizes with the target E-Node B (i.e. HO/Rx shared CH from target cell).

Next, the UE reports to the target E-Node B that the handover to the target E-Node B is complete (i.e. RB reconfiguration complete) (step ST16).

Next, the target E-Node B sends a path switch request to the access gateway (step ST17). The access gateway, having received the path switch request, establishes an IP tunnel by changing the destination address from the source E-Node B to the target E-Node B (hereinafter “path switching”).

Next, the access gateway starts releasing the source E-Node B (i.e. release) (step ST18).

In this way, in FIG. 1, the source E-Node B determines the target E-Node B based on received quality and so on at the UE, and makes preparations related to the handover of the UE between the source E-Node B and the target E-Node B. After the UE has established a complete connection to the target E-Node B, the UE switches the data path from the access gateway from the source E-Node B to the target E-Node B, and thereupon the handover is complete.

According to an IETF mobile IP, in step ST12 of FIG. 1, after the “context transfer” has been sent from the source network host to the destination network host, the destination network host sends a mobile IP registration request to the access gateway (not shown in FIG. 1). The context transfer then contains the home address of the mobile terminal, so that the destination network host is able to create a mobile IP table. After a mobile IP table has been created, the destination network host sends a mobile IP registration response to the source network host. Here, “mobile IP” refers to a technique of adding positional information to the original IP address, so that, wherever the mobile terminal moves to, the mobile terminal is able to carry out communications using the same IP address.

Non-Patent Document 1: TSGR3(05) 1106, “EUTRAN handover procedure for LTE_ACTIVE,” Joint RAN2-RAN3 #48bis LTE Cannes, France, 11-14 Oct. 2005

### DISCLOSURE OF INVENTION

### Problems to be Solved by the Invention

However, with the above conventional method, the access gateway switches the data path from the source E-Node B to the target E-Node B after the mobile terminal has established a complete connection with the target E-Node B. By this means, when the mobile terminal disconnects with the source E-Node B and then connects with the target E-Node B, that is, when the mobile terminal performs a “hard handover,” although the connection between the mobile terminal and the source E-Node B is cut during the period the mobile terminal performs the handover until the path switch is complete, that is, from step ST15 to step ST17 in FIG. 1, packets for the mobile terminal arrive at the source E-Node B. Therefore, the source E-Node B needs to transfer the packets that have arrived after the mobile terminal performs has performed a handover until the path switch is complete, to the target E-Node B, which results in a problem that the mobile terminal occupies resources for the source E-Node B to which the mobile terminal is no longer connected, and involves load accompanying the transfer.

It is therefore an object of the present invention to provide a communication apparatus and a handover method that allow effective use of resources for the handover source network host and eliminate the processing load accompanying data transfer, by controlling the timing for switching the data path in higher apparatus and preventing data transfer from the handover source network host to the handover destination network host.

### Means for Solving the Problem

The communication apparatus according to the present invention adopts a configuration including: a handover determining section that determines whether or not a communication terminal apparatus performs a handover from the communication apparatus to another communication apparatus, based on received quality at the communication terminal apparatus; a switch requesting section that, when the handover determining section determines that the handover is going to be performed, issues a request for path switching, so that data for the communication terminal apparatus, sent from higher apparatus to the communication apparatus, is redirected and sent from the higher apparatus to the another communication apparatus, before the handover; and a handover commanding section that, when the path switching request is granted, commands the communication terminal apparatus to perform the handover from the communication apparatus to the another communication apparatus.

The handover method according to the present invention includes: a step, in which whether or not a communication terminal apparatus performs a handover, is determined in a handover source, based on received quality at the communication terminal apparatus; a step, in which, when the handover is determined to be performed, a request for path switching is issued from the handover source, so that data for the communication terminal apparatus, sent from higher apparatus to the handover source, is redirected and sent from the higher apparatus to a handover destination, before the handover; a step, in which, when the path switching request is granted, the handover source commands the communication terminal apparatus to perform the handover; and a step, in which the communication terminal apparatus having received the command performs the handover.

### ADVANTAGEOUS EFFECT OF THE INVENTION

The present invention controls the timing for switching the data path in higher apparatus, to prevent data transfers from the handover source network host to the handover destination network host, so that it is possible to allow effective use of resources for the handover source network host and eliminate the processing load accompanying data transfer.

### BRIEF DESCRIPTION OF DRAWINGS

FIG. 1 is a sequence diagram showing a conventional handover method;

FIG. 2 is a block diagram showing a configuration of a communication apparatus according to Embodiment 1 of the present invention;

FIG. 3 shows a network architecture according to Embodiment 1 of the present invention;

FIG. 4 is a sequence diagram showing a handover method according to Embodiment 1 of the present invention; and

FIG. 5 shows Ethernet data and ARP message formats according to Embodiment 2 of the present invention.

### BEST MODE FOR CARRYING OUT THE INVENTION

Hereinafter, embodiments of the present invention will be explained in detail below with reference to the accompanying drawings.

### Embodiment 1

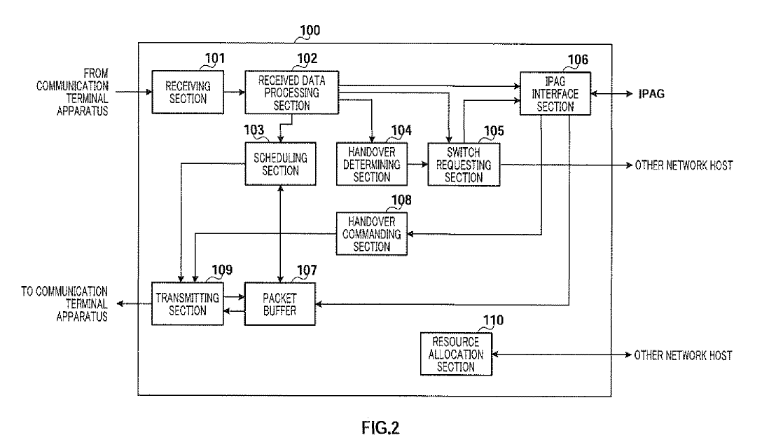

FIG. 2 is a block diagram showing the architecture of network host 100 which is a communication apparatus according to Embodiment 1 of the present invention. Handover determining section 104, switch requesting section 105 and handover commanding section 108 perform processing when network host 100 is the handover source, and resource allocation section 110 performs processing when network host 100 is the handover destination.

Receiving section 101 receives a signal transmitted from a communication terminal apparatus using a radio channel, down-converts the received signal from radio frequency to baseband frequency and outputs the received signal to received data processing section 102.

Received data processing section 102 demodulates the received signal inputted from receiving section 101 and disassembles the received signal into the data part and the control data part. Received data processing section 102 outputs the disassembled data part to IP access gateway (hereinafter “IPAG”) interface section 106 and meanwhile outputs the disassembled control data part to scheduling section 103, handover determining section 104 and switch requesting section 105.

Scheduling section 103 performs scheduling based on received quality information, which is information about the received quality in the communication terminal apparatus, included in the control data part inputted from received data processing section 102, and based on queue information, which is information about the amount of data, stored in packet buffer 107 inputted from packet buffer 107. For example, scheduling section 103 holds a table storing scheduling information which associates received quality such as CQI (Channel Quality Indicator) with the amount of transmission data. Scheduling section 103 then selects the amount of transmission data with reference to the scheduling information using the received quality in received quality information such as the CQI inputted from received data processing section 102 and also with reference to the queue information. Furthermore, scheduling section 103 controls transmitting section 109 to transmit only the selected amount of transmission data.

Handover determining section 104 selects the handover destination network host based on the received quality information about a plurality of network hosts included in the control data part inputted from received data processing section 102. Handover determining section 104 then outputs handover destination information, which is information about the determined handover destination network host, to switch requesting section 105.

To request path switching to the IPAG, which is the processing of switching the path to the network host of the handover destination information inputted from handover determining section 104, switch requesting section 105 creates a switch request message, which is a message for requesting path switching. To be more specific, switch requesting section 105 creates an IP registration request message as a switch request message. In this case, switch requesting section 105 sets the IP address of the network host of the handover destination information in the c/o address field in the IP registration request message and meanwhile sets the IP address of the communication terminal apparatus in the home address field in the IP registration request message. Switch requesting section 105 then outputs the created IP registration request message, to IPAG interface section 106.

Furthermore, as a proxy for the IPAG, switch requesting section 105 creates a mobile IP registration response message, which is a response message to the IP registration request message Switch requesting section 105 sends the created mobile IP registration response message, to the network host of the handover destination information. Furthermore, switch requesting section 105 sends the radio bearer information and QoS information and so on of the communication terminal apparatus that performs the handover, included in the control data part inputted from received data processing section 102, to the network host of the handover destination information.

IPAG interface section 106 is connected to the IPAG via cable and sends the data part inputted from received data processing section 102 to the IPAG. Furthermore, IPAG interface section 106 outputs the data part received from the IPAG, to packet buffer 107. Furthermore, IPAG interface section 106 sends to the IPAG the switch request message inputted from switch requesting section 105 and meanwhile outputs to handover commanding section 108 a switch allowing message for reporting that the request for switching the path switch received from the IPAG is granted.

Packet buffer 107 outputs the queue information to scheduling section 103. Furthermore, packet buffer 107 stores the data inputted from IPAG interface section 106 on a temporary basis. Packet buffer 107 then outputs packet data, in the amount of data specified by transmitting section 109, to transmitting section 109 at predetermined timing.

Upon receiving the switch allowing message from IPAG interface section 106 as input, handover commanding section 108 outputs a message commanding the communication terminal apparatus to perform a handover to the handover destination network host, to transmitting section 109.

Transmitting section 109 commands packet buffer 107 to output data in the amount of data specified by scheduling section 103, and sends packet data of the specified amount, inputted from packet buffer 107, using radio signals. Furthermore, transmitting section 109 sends the message commanding a handover, inputted from handover commanding section 108, using a radio signal.

Resource allocation section 110 books the resources which the communication terminal apparatus requires, based on the radio bearer information, QoS information and so on of the communication terminal apparatus that performs the handover, and based on resource information, which is information about the resources that are available for allocation, sent from the counterpart network host, that is, the handover source. Upon successfully booking resources, resource allocation section 110 creates a message reporting that the preparation for the handover is complete. Resource allocation section 110 then sends the created message to the handover source network host.

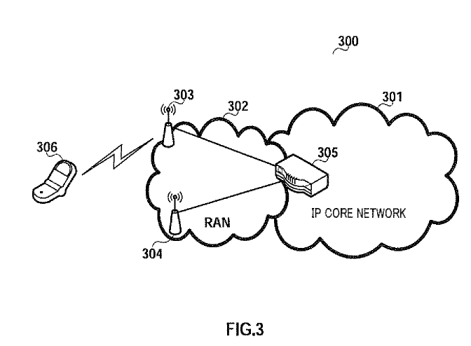

FIG. 3 shows the architecture of network 300 according to embodiment 1. Network 300 is made up of IP-based core network 301 and radio access network (RAN) 302. Network hosts 303 and 304 are located on RAN 302 and are connected to IPAG 305 via cable. IPAG 305 is located in IP core network 301 and serves as a gateway for external networks. Communication terminal apparatus 306 accesses network host 303 using radio access technology, and communicates with external networks via IPAG 305.

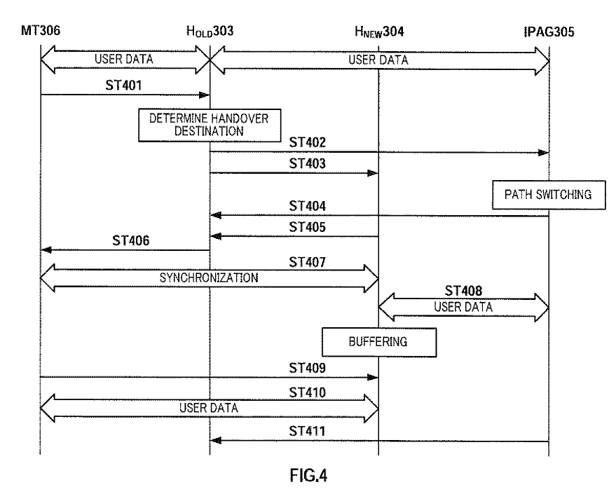

Next, the method communication terminal apparatus 306 performs a handover, will be explained using FIG. 4. FIG. 4 is a sequence diagram showing the handover method. In FIG. 4 and explanation of FIG. 4, communication terminal apparatus 306 is “MT,” handover source network host 303 is “H_{OLD}” and handover destination network host 304 is “H_{NEW},” for ease of explanation. Furthermore, H_{OLD} 303 and H_{NEW} 304 have the same configuration as in FIG. 2.

First, MT 306 reports to H_{OLD} 303 the received quality of candidates H_{OLD} 303 and H_{NEW} 304 at MT 306, so that H_{OLD} 303 can determine appropriate H_{NEW} 304 for the handover of MT 306 (i.e. measurement report) (step ST401). Furthermore, when reporting received quality, MT306 reports to H_{OLD} 303 an IP address, which is the home address of MT 306 (step ST401).

Next, H_{OLD} 303 determines, in handover determining section 104, whether or not a handover is performed, based on the reported received quality, resources that are available for allocation and processing load, and determines, if a handover is going to be performed, H_{NEW} 304 to be the handover destination (i.e. handover decision). This allows H_{OLD} 303 to specify the IP address of H_{NEW} 304, which is the handover destination.

Next, H_{OLD} 303 requests a change of the path from H_{OLD} 303 to H_{NEW} 304 by sending to IPAG 305 a path switch request, which is a message generated by switch requesting section 105 (step ST402). In this case, H_{OLD} 303 creates an IP registration request message through switch requesting section 105, sets the IP address of MT 306 reported from MT 306 in step ST401 in the home address field in the IP registration request message, sets the IP address of H_{NEW} 304 in the c/o address field in the IP registration request message, and sets the IP address of H_{OLD} 303 in the IP header as the sender IP address. The, as a proxy for H_{NEW} 304, H_{OLD} 303 sends the created mobile IP registration request message to IPAG 305.

Next, H_{OLD} 303 sends a message including the radio bearer information, QoS information and information about the IP address of MT 306, to H_{NEW} 304 (i.e. context transfer) (step ST403). The home address of MT 306 is set in the context transfer, so that H_{NEW} 304, upon receiving the context transfer, creates a mobile IP table in the same manner as in cases of conventional schemes of receiving a mobile IP registration response from IPAG 305.

Next, upon receiving the mobile IP registration request message, IPAG 305 creates a mobile IP table in the same manner as in cases of conventional schemes of receiving the mobile IP registration request from H_{NEW} 304. IPAG 305 then carries out path switching by changing the destination address from H_{OLD} 303 to H_{NEW} 304 (i.e. path switching). This allows IPAG 305 to send packets to H_{NEW} 304.

Next, IPAG 305 sends to H_{OLD} 303 a path switch reply, which is a message for reporting that path switching is complete (step ST404). Furthermore, when there is no problem with the content of the mobile IP registration request message, IPAG 305 sends a mobile IP registration response message to H_{OLD} 303, as a response to the mobile IP registration request message (step ST404).

Next, upon successfully booking the resources which MT 306 requires, H_{NEW} 304 reports to H_{OLD} 303 that the preparation for the handover is complete, through resource allocation section 110 (i.e. context transfer response) (step ST405).

Next, upon receiving the two messages, namely the mobile IP registration response message and context transfer response, H_{OLD} 303 commands MT 306 to perform a handover from H_{OLD} 303 to H_{NEW} 304, through handover commanding section 108 (i.e. RB reconfiguration) (step ST406) Furthermore, H_{OLD} 303 sends the cell-specific parameters to MT 306, which are necessary to communicate with H_{NEW} 304 (step ST406).

Next, upon receiving the RB reconfiguration, MT 306 starts re-webbing the radio links from H_{OLD} 303 to H_{NEW} 304. MT 306 then synchronizes with H_{NEW} 304 (i.e. radio L1 & L2 establishment) (step ST407).

Next, IPAG 305 sends to H_{NEW} 304 the user data, which is packets for MT 306 (step ST408).

H_{NEW} 304 performs buffering, which is the processing of storing the packets for MT 306 sent from IPAG 305, in packet buffer 107 (i.e. data buffering).

Next, MT 306 reports to H_{NEW} 304 that the handover to H_{NEW} 304 is complete (i.e. RB reconfiguration complete) (step ST409).

Next, H_{NEW} 306, having received the RB reconfiguration complete from MT 306, starts sending buffered packets for MT 304 (step ST410).

Next, IPAG 305 starts releasing H_{OLD} 303 (i.e. resource release) (step ST411).

In this way, according to Embodiment 2, at the timing the handover source network host determines to perform a handover, the handover source network host requests path switching to the IPAG, so that the need for transferring data from the handover source network host to the handover destination network host is eliminated, and, consequently, it is possible to use the resources for the handover source network host efficiently and furthermore eliminate the processing load accompanying data transfer.

Furthermore, according to embodiment 1, the handover source network host sends a mobile IP registration request message at the timing of determining to perform a handover, so that a mobile IP table can be created in the IPAG faster than in the prior art.

Furthermore, according to embodiment 1, as a proxy for the handover destination network host, the handover source network host issues a mobile IP registration request to the IPAG, and, as a proxy for the IPAG, sends a mobile IP registration response to the handover destination network host, so that it is possible to create mobile IP tables in the IPAG and in the handover destination network host through similar processing to conventional schemes, and, consequently, the need for changing the system and apparatus is eliminated and the cost required to build the system can be reduced.

Furthermore, according to embodiment 1, the IPAG creates a mobile IP table by receiving a mobile IP registration request message, and, meanwhile, the handover destination network host creates a mobile IP table by receiving a mobile registration response message, so that the IPAG and handover destination network host can create mobile IP tables virtually at the same time, making possible a faster network path switch than the prior art.

### Embodiment 2

Embodiment 2 is different from embodiment 1 above in that, upon requesting path switching to the IPAG, the handover source network host sends an ARP (address resolution protocol) message, instead of a mobile IP registration request message.

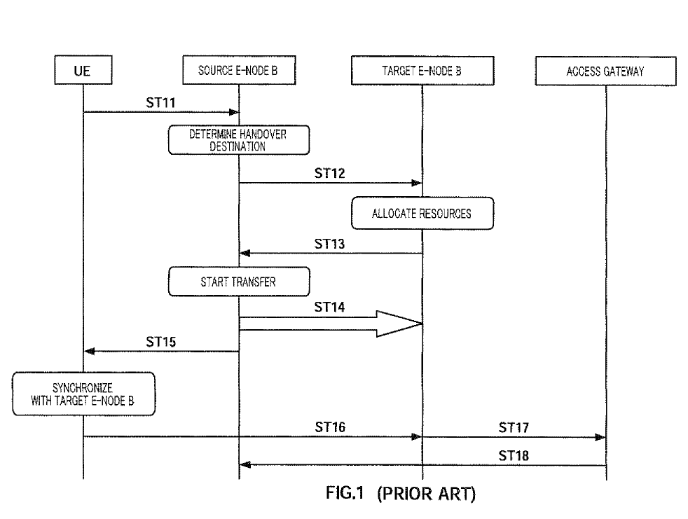

The configuration of the network host, which is the communication apparatus according to present embodiment 2, is the same as in FIG. 1, except for the processing in switch requesting section 105, and therefore explanations for other components than switch requesting section 105 will be omitted.

To request path switching to the IPAG, which is the processing of switching the path to the network host of the handover destination information inputted from handover determining section 104, switch requesting section 105 creates a switch request message, which is a message for requesting path switching. To be more specific, switch requesting section 105 creates an ARP message as a switch request message. In this case, switch requesting section 105 sets the address of the IPAG in the unicast address field in the ARP message, sets the layer 2 address of the handover destination network host in the sender layer 2 address field in the ARP message and sets the layer 3 address of the communication terminal apparatus in the sender layer 3 address field in the ARP message. Switch requesting section 105 then outputs the created ARP message to IPAG interface section 106.

Furthermore, as a proxy for the IPAG, switch requesting section 105 creates an ARP response message, which is a response message to the transmission of the ARP message. Switch requesting section 105 sends the created ARP response message, to the handover destination network host. Furthermore, switch requesting section 105 sends to the handover destination network host the radio bearer information and QoS information and so on of the communication terminal apparatus that performs the handover, included in the control data part inputted from received data processing section 102. The format of the ARP message will be described later.

Next, the method the communication terminal apparatus performs a handover will be explained. Since the handover method according to embodiment 2 is the same as that in FIG. 4, except for step ST402 and the processing of path switching, explanations of other processing than step ST402 and path switching processing, will be omitted.

H_{OLD} 303 request a change of the path from H_{OLD} 303 to H_{NEW} 304 by sending a path switch request, which is a message generated by switch requesting section 105, to IPAG 305 (step ST402). In this case, H_{OLD} 303 creates an ARP message in switch requesting section 105, sets the address of IPAG 305 in the unicast address field, sets the layer 2 address of H_{NEW} 304 in the sender layer 2 address field, and sets the IP address of MT 306, which is the layer 3 address of MT 306 reported from MT 306 in step ST401, in the sender layer 3 address field. Then, as a proxy for H_{NEW} 304, H_{OLD} 303 sends the created ARP message to IPAG 305.

Here, ARP refers to the protocol that is generally used to find out the physical address of the communicating party apparatus whose IP address is known. The communication apparatus of the query source broadcasts an ARP message specifying the IP address of the communicating party apparatus, to all of the communication apparatuses on the network. The communication apparatus matching the specified IP address, knows its own physical address and IP address, and sends back a response message that pairs its physical address and IP address, to the communication apparatus of the query source. This allows the communication apparatus of the query source to create and update an entry of the pair of the physical address and IP address. Embodiment 2 sets the address of IPAG 305 (i.e. unicast address) in the unicast field, instead of setting the addresses of all communication apparatuses (i.e. broadcast addresses) in the broadcast field in the ARP message, so that the IPAG alone is able to receive the ARP message.

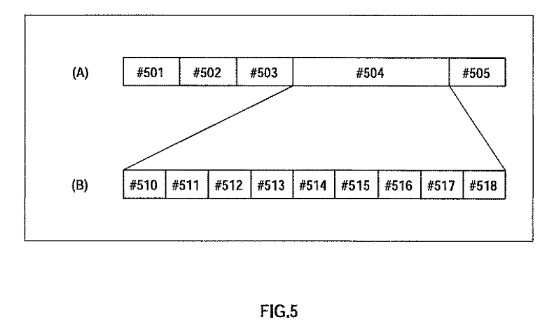

FIG. 5 shows Ethernet data and ARP message formats. FIG. 5(A) shows a format of Ethernet data and FIG. 5(B) shows a format for the ARP message included in Ethernet data.

As shown in FIG. 5(A), Ethernet data is made up of: destination address (i.e. dest address) field #501, in which the data transmission destination is set; source address (i.e. source address) field #502, in which the address of the sender is set; ARP identification (i.e. Ethernet Type) field #503, in which information for identifying the ARP message is set; ARP (i.e. ARP Request/Reply) field #504, in which the content of the ARP message is set; and frame check sequence (i.e. FCS) field #505 for checking errors during transmission.

As shown in FIG. 5(B), ARP field #504 is made up of HARD TYPE field #510, PROT TYPE field #511, HARD SIZE field #512, PROT SIZE field #513, OP field #514, sender layer 2 address (i.e. sender Ether addr) field #515, sender layer 3 address (i.e. sender IP addr) field #516, destination layer 2 address (i.e. target Ether addr) field #517 and destination layer 3 address (i.e. Target IP addr) field #518. OP field #514 is used to make an inquiry when it is not clear to which communicating party apparatus a certain IP address is assigned, and, when “1” is set in OP field #514, this indicates that the transmitting side is requesting a response from the communicating party apparatus to which the certain IP address is assigned, and, when “2” is set in OP field #514, this indicates that a response has been sent from the receiving side.

As for the ARP message sent from H_{OLD} 303, H_{OLD} 303 sets the Ethernet address of H_{NEW} 304, which is the layer 2 address of H_{NEW} 304 in sender layer 2 address field #515, sets the IP address of MT 306, which is the layer 3 address of MT 306 in sender layer 3 address field #516, sets the Ethernet address of IPAG 305, which is the layer 2 address of IPAG 305, which is the communicating party, to which a change of the layer 2 address is to be reported, in destination layer 2 address field #517, and sets the Ethernet address of IPAG 305, which is the layer 2 address of IPAG 305, in destination layer 3 address field #518. On the other hand, as for the ARP message sent from H_{OLD} 303, H_{OLD} 303 sets the Ethernet address of IPAG 305, which is the layer 2 address of IPAG 305, in destination address field #501, and sets the Ethernet address of H_{OLD} 303, which is the layer 2 address of H_{OLD} 303, in sender address field #502. In the normal ARP message, the broadcast address is set in destination address field #501. However, according to embodiment 2, the Ethernet address of IPAG 305 (i.e. unicast address) is set in destination address field #501.

IPAG 305, having received the above described ARP message, removes the pair of the Ethernet address of H_{OLD} 303 and IP address of MT 306, stored in an ARP table of an ARP cache, and stores the pair of the Ethernet address of H_{NEW} 304 set in sender layer 2 address field #515 and the IP address of MT 306 set in sender layer 3 address field #516 in the ARP table of the ARP cache.

In this way, according to Embodiment 2, at the timing the handover source network host determines to perform a handover, the handover source network host requests path switching to the IPAG, so that the need for transferring data from the handover source network host to the handover destination network host is eliminated, and, consequently, it is possible to use the resources for the handover source network host efficiently and furthermore eliminate the processing load accompanying data transfer.

Furthermore, according to embodiment 1, the handover source network host sends an ARP message at the timing of determining to perform a handover, so that an ARP table can be created in the IPAG faster than in the prior art.

Furthermore, according to embodiment 2, as a proxy for the handover destination network host, the handover source network host sends an ARP message to the IPAG, and, as a proxy for the IPAG, sends a reply to the transmission of the ARP message to the handover destination network host, so that it is possible to create ARP tables in the IPAG and handover destination network host through similar processing to conventional schemes, and, consequently, the need for changing the system and apparatus is eliminated and the cost required to build the system can be reduced.

Furthermore, according to embodiment 2, the IPAG creates an ARP table by receiving an ARP message, and, meanwhile, the handover destination network host creates an ARP table by receiving an ARP message, so that the IPAG and handover destination network host can create ARP tables virtually at the same time, making possible a faster network path switch than the prior art.

### INDUSTRIAL APPLICABILITY

The communication apparatus and handover method according to the present invention are suitable for use in, for example, packet communications using mobile IP technology.

1. A communication apparatus comprising:
a handover determining section that determines whether or not a communication terminal apparatus performs a handover from the communication apparatus to another communication apparatus, based on received quality at the communication terminal apparatus;
a switch requesting section that, when the handover determining section determines that the handover is going to be performed, issues a request for path switching, so that data for the communication terminal apparatus, sent from higher apparatus to the communication apparatus, is redirected and sent from the higher apparatus to the another communication apparatus, before the handover; and
a handover commanding section that, when the path switching request is granted, commands the communication terminal apparatus to perform the handover from the communication apparatus to the another communication apparatus.

2. The communication apparatus according to claim 1, wherein the switch requesting section sends to the higher apparatus an internet protocol address registration request message comprising the path switching request in which an internet protocol address of the another communication apparatus and an internet protocol address of the communication terminal apparatus, are stored in predetermined fields.

3. The communication apparatus according to claim 1, wherein the switch requesting section sends an address resolution protocol message to the higher station as the path switching request, the address resolution protocol message storing a layer 2 address of the another communication apparatus and a layer 3 address of the communication terminal apparatus in a field for reporting a sender and storing a unicast address of the higher apparatus instead of a broadcast address, and being used to find out a physical address of a communicating party whose internet protocol address is known.

4. The communication apparatus according to claim 1, wherein, as a proxy for the higher apparatus, the switch requesting section sends a response to the path switching request, to the another communication apparatus.

5. A handover method comprising:
a step, in which whether or not a communication terminal apparatus performs a handover, is determined in a handover source, based on received quality at the communication terminal apparatus;
a step, in which, when the handover is determined to be performed, a request for path switching is issued from the handover source, so that data for the communication terminal apparatus, sent from higher apparatus to the handover source, is redirected and sent from the higher apparatus to a handover destination, before the handover;
a step, in which, when the path switching request is granted, the handover source commands the communication terminal apparatus to perform the handover; and
a step, in which the communication terminal apparatus having received the command performs the handover.
